(19) United States
(12) Patent Application Publication
(10) Pub. No.: US 2025/0242961 A1
(43) Pub. Date: Jul. 31, 2025

(54) FILM TRANSFER TOOL

(71) Applicant: SDI CORPORATION, CHANG HUA (TW)

(72) Inventors: Ming Cheng Wei, CHANG HUA (TW); Cheng-Yu PAI, CHANG HUA (TW); Chien-Lung WU, CHANG HUA (TW)

(73) Assignee: SDI CORPORATION, CHANG HUA (TW)

(21) Appl. No.: 18/975,582

(22) Filed: Dec. 10, 2024

(30) Foreign Application Priority Data
Jan. 25, 2024 (TW) 113103011

(51) Int. Cl. B65C 9/18; B65C 11/00

(52) U.S. Cl. CPC B65C 9/1869; B65C 11/00; B65C 2210/0081; B65C 2210/0091

(57) ABSTRACT

A film transfer tool has a casing, a tape-supplying assembly having a supply reel and a take-up reel linked therewith, a brake component which can move relative to the supply reel, and a transfer head. The transfer head moves between an original position and an operating position to drive the tape-supplying assembly and the brake component to move relative to the other. When the transfer head moves toward the operating position, a relative movement between the supply reel and the brake component is caused and the braking capacity gradually decreases.

### BACKGROUND OF THE INVENTION

### 1. Field of the Invention

The present invention relates to a film transfer tool, and more particularly to a film transfer tool capable of applying a progressive brake torque on a supply reel.

### 2. Description of Related Art

A conventional film transfer tool, such as a correction tape dispenser, comprises a casing, a tape-supplying assembly, and a transfer head. The tape-supplying assembly is installed in the casing and comprises a supply reel, a take-up reel, and a transfer tape. Two ends of the transfer tape are respectively wound around the supply reel and the take-up reel, and on the part wound around the supply reel, one side of the transfer tape is coated with a white, opaque material (e.g. titanium dioxide). The transfer head collaborates with the tape-supplying assembly and protrudes from the casing. A part of the transfer tape is wrapped over the transfer head.

A user may abut the part of the transfer tape over the transfer head onto a paper surface and draw the conventional film transfer tool across the paper surface. Thereby, the transfer tape will move as being dragged by tension and drive the supply reel and the take-up reel to rotate, wherein the supply reel will release the transfer tape (with coating) and the take-up reel will wind up the used part of the transfer tape, so the coating can be transferred onto the transfer surface.

At a beginning stage (of use of a new tape-supplying assembly), there is much more part of the transfer tape wound around the supply reel than that wound around the take-up reel. Therefore, tension of the transfer tape will cause a higher torque to rotate the supply reel than a torque to rotate the take-up reel, leading to the supply reel overly prone to rotation at ease, which makes the user tend to neglect pressing the conventional film transfer tool properly in operation. Hence, coating cannot be tidily transferred from the transfer head to the paper surface, a break edge of coating is prone to be a ripped edge, or even a break edge forms a small piece protruding from the transfer head. The ripped edge not only harms aesthetic appeal of the coating, but also may adhere to other objects.

The conventional film transfer tool utilizes gearing between the supply reel and the casing to prevent the supply reel from being easily rotated and to maintain operation tension of the transfer tape to prevent the transfer tape from being loosened. However, gearing can only sustain a fixed tension and cannot properly solve the abovementioned problem of tension changing. In addition, gearing makes the user feel bumpy in operation, i.e. unsmooth engagement and separation of teeth of gearing, leading to an unwanted user experience.

### SUMMARY OF THE INVENTION

The main objective of the present invention is to provide a film transfer tool capable of applying a gradually-changing brake torque on a supply reel, so as to mitigate the shortcomings of the conventional film transfer tool.

The film transfer tool of the present invention comprises a casing, a tape-supplying assembly, a brake component, a transfer head, and an elastic component. The tape-supplying assembly is disposed in the casing and comprises a supply reel and a take-up reel linked with the supply reel. The brake component is disposed in the casing and is configured to move relative to the supply reel. The transfer head has an end extending into the casing, is connected with the tape-supplying assembly, and is configured to move relative to the tape-supplying assembly between an original position and an operating position and to drive one of the tape-supplying assembly and the brake component to move relative to the other one of the tape-supplying assembly and the brake component. The elastic component is disposed in the casing and is configured to provide a resilient force to drive the transfer head to move toward the original position.

When the transfer head is located in the original position, the brake component abuts against the supply reel and provides a maximum braking capacity. When the transfer head moves from the original position toward the operating position, a relative movement between the supply reel and the brake component is caused and the braking capacity gradually decreases.

Thereby, when operating the film transfer tool in accordance with the present invention, a user abuts the transfer head on a paper surface, making the transfer head move from the original position to the operating position, the supply reel and the brake component will be driven to move relatively, and the braking capacity will gradually decrease accordingly. Thereby, a resistance applied on the supply reel is gradually relieved and serves as the gradually-changing brake torque. The film transfer tool of the present invention can not only neatly break coating of the tape-supplying assembly, but can also smoothly release braking without a bumpy feel so as to improve user experience, effectively mitigating the shortcomings of the conventional film transfer tool.

Since the transfer head should be abutted in operation, along with the gradually-changing brake torque, coating will be transferred much flatter when being applied on the paper surface. Moreover, the film transfer tool of the present invention does not generate noise of gear engagement compared to the conventional one, and thereby allows a quiet tape application.

### BRIEF DESCRIPTION OF THE DRAWINGS

FIG. 1 is a top-perspective exploded view of a first embodiment of the film transfer tool in accordance with the present invention;

FIG. 2 is a bottom-perspective exploded view of the film transfer tool of FIG. 1;

FIG. 3 is a cross-sectional side view of the film transfer tool of FIG. 1 with a transfer head located in an original position;

FIG. 4 is an operational cross-sectional side view of the film transfer tool of FIG. 1;

FIG. 5 is a cross-sectional side view of the film transfer tool of FIG. 1 with the transfer head located in an operating position;

FIG. 6 is a cross-sectional side view of a second embodiment of the film transfer tool in accordance with the present invention with a transfer head located in an original position;

FIG. 7 is a perspective view of a supply reel of the film transfer tool of FIG. 6;

FIG. 8 is a cross-sectional side view of the film transfer tool of FIG. 6 with the transfer head located in an operating position;

FIG. 9 is a cross-sectional side view of a third embodiment of the film transfer tool in accordance with the present invention with a transfer head located in an original position;

FIG. 10 is a cross-sectional side view of the film transfer tool of FIG. 9 with the transfer head located in an operating position;

FIG. 11 is a cross-sectional side view of a fourth embodiment of the film transfer tool in accordance with the present invention with a transfer head located in an original position;

FIG. 12 is a cross-sectional side view of the film transfer tool of FIG. 11 with the transfer head located in an operating position;

FIG. 13 is a cross-sectional side view of a fifth embodiment of the film transfer tool in accordance with the present invention with a transfer head located in an original position;

FIG. 14 is a perspective view of a brake component of the film transfer tool of FIG. 13; and

FIG. 15 is a cross-sectional side view of the film transfer tool of FIG. 13 with the transfer head located in an operating position.

### DETAILED DESCRIPTION OF THE PREFERRED EMBODIMENTS

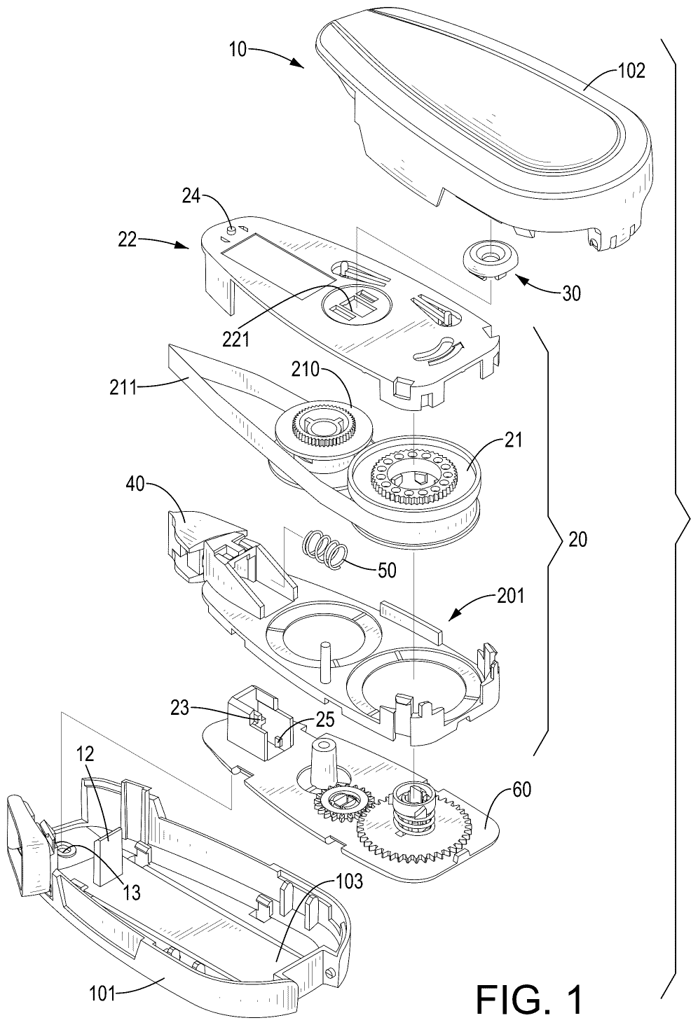

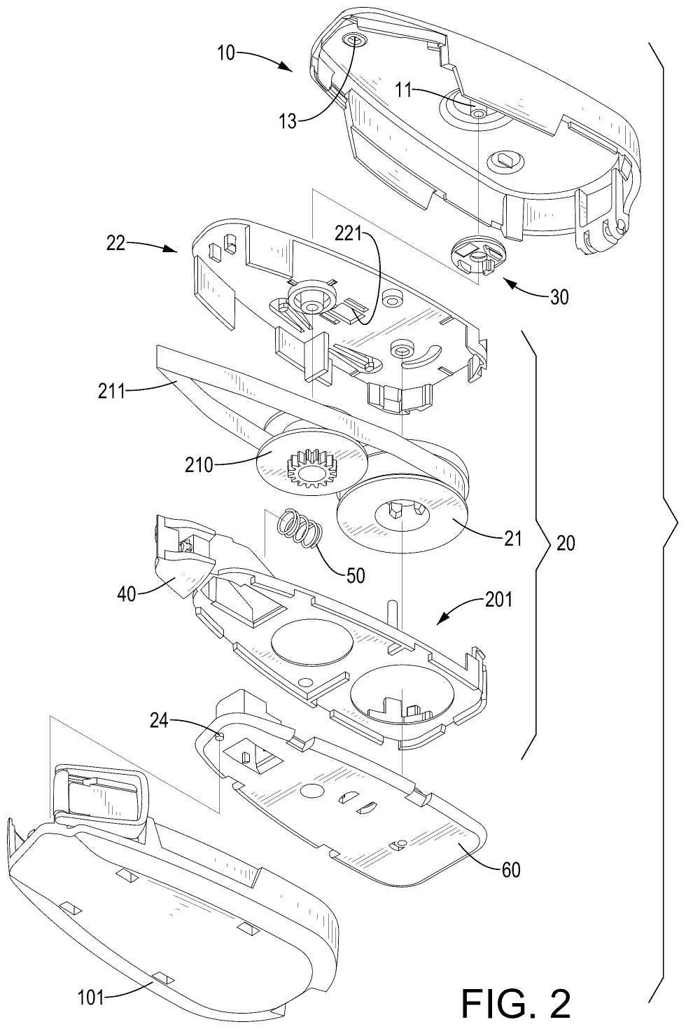

With reference to FIGS. 1 to 5, a first embodiment of a film transfer tool in accordance with the present invention comprises a casing 10, a tape-supplying assembly 20, a brake component 30, a transfer head 40, and an elastic component 50. With reference to FIGS. 1 to 3, the casing 10 forms a receiving space 103 inside for receiving the above-mentioned components.

With reference to FIGS. 1 to 3, the tape-supplying assembly 20 is disposed in the receiving space 103 of the casing 10 and comprises a supply reel 21, a take-up reel 210, and a transfer tape 211 wound around the supply reel 21 and the take-up reel 210. The transfer tape 211 being in the casing 21 and linking the supply reel 21 and the take-up reel 210 and its working principles are identical with those of the prior art, so detailed description thereof is omitted.

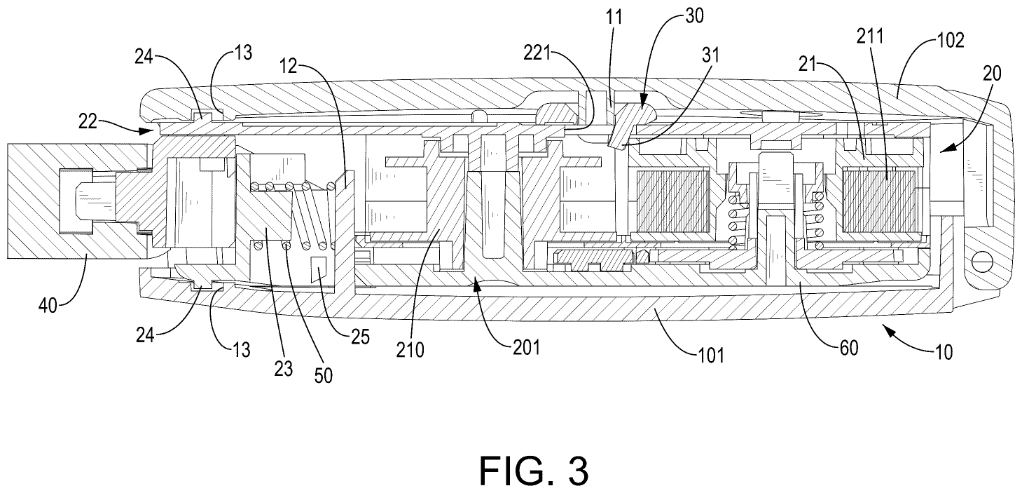

The brake component 30 is disposed in the receiving space 103 of the casing 10. With reference to FIGS. 3 to 5, the brake component 30 is configured to move relative to the supply reel 21.

With reference to FIGS. 1, 3 to 5, the transfer head 40 has an end extending into the casing 10 and connected with the tape-supplying assembly 20.

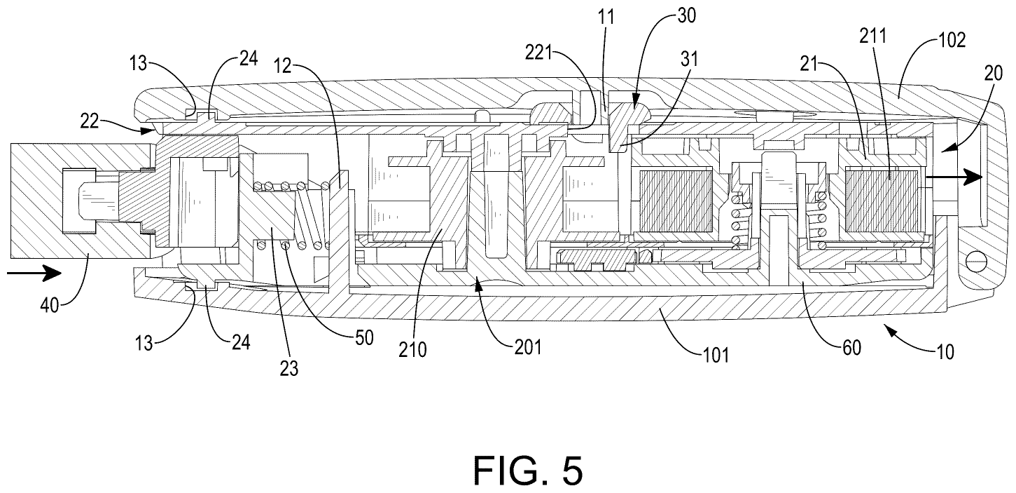

With reference to FIGS. 3 to 5, the transfer head 40 is configured to move relative to the casing 10 between an original position (as shown in FIG. 3) and an operating position (as shown in FIG. 5) and to drive one of the tape-supplying assembly 20 and the brake component 30 to move relative to the other.

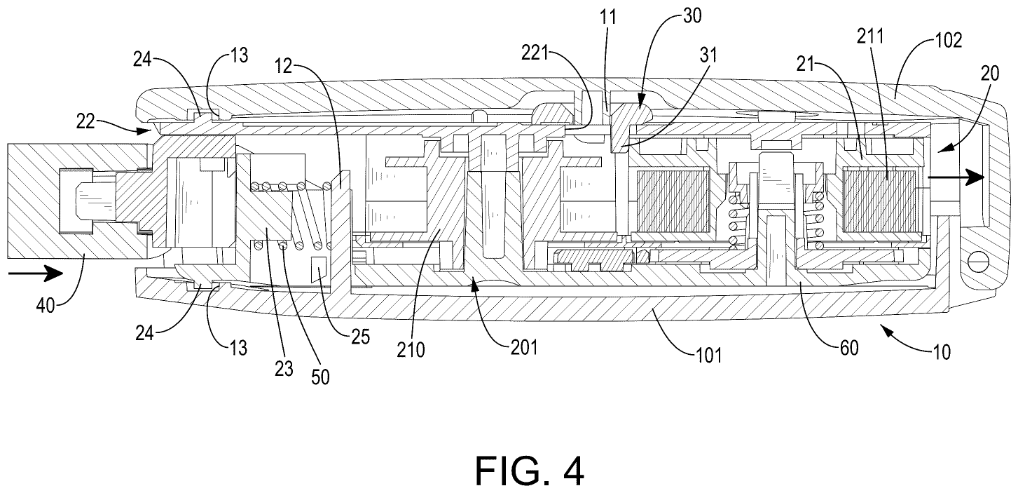

With reference to FIGS. 1, 3 to 5, the elastic component 50 is disposed in the receiving space 103 of the casing 10, and is capable of providing a resilient force to drive the transfer head 40 to move toward the original position. With reference to FIG. 3, when the transfer head 40 is located in the original position, the brake component 30 abuts against the supply reel 21 and applies a maximum braking capacity. With reference to FIGS. 4 and 5, when the transfer head 40 moves from the original position toward the operating position, the supply reel 21 moves relative to the brake component 30 and makes the braking capacity gradually decrease.

The braking capacity refers to a potential torque which may be generated by a frictional force, and is equal to a product of a frictional force between the brake component 30 and the supply reel 21 and an equivalent moment arm. The equivalent moment arm is namely a length between where the supply reel 21 is abutted by the brake component 30 and an axle of the supply reel 21. The maximum braking capacity is equivalent to a maximum static friction between the brake component 30 and the supply reel 21 and where they abut on each other. Adjusting the braking capacity can make the supply reel 21 properly maintain a suitable tension for the transfer tape 211, so as to provide a neat and good-looking coating breaking effect. Relative movement of the supply reel 21 and the brake component 30 gradually decreases the braking capacity that the brake component 30 applies on the supply reel 21 and gradually lowers the braking torque.

With the brake component 30 abutting against the supply reel 21, at the moment that the transfer tape 211 is dragged and thereby drives the supply reel 21 to rotate, the frictional force between the brake component 30 and the supply reel 21 generates a torque resisting rotation of the supply reel 21. Therefore, the supply reel 21 can be prevented from being rotated and releasing the transfer tape 211 easily, and can also adjust the tension of the transfer tape 211.

Thereby, when operating the film transfer tool in accordance with the present invention, the user abuts the transfer head 40 on a paper surface, making the transfer head 40 move from the original position to the operating position, thereby driving the supply reel 21 and the brake component 30 to move relatively, i.e. the supply reel 21 moves or the brake component 30 moves to change a distance between the supply reel 21 and the brake component 30, and the braking capacity will gradually decrease accordingly. Thereby, a resistance applied on the supply reel 21 is gradually relieved and serves as a gradually-changing brake torque. The film transfer tool of the present invention can not only neatly break coating of the tape-supplying assembly, but can also smoothly release braking without a bumpy feel so as to improve user experience, effectively mitigating the shortcomings of the conventional film transfer tool.

Since the transfer head 40 should be abutted in operation, along with the gradually-changing brake torque, coating will be transferred much flatter when being applied on the paper surface. Moreover, the film transfer tool of the present invention does not generate noise of gear engagement compared to the conventional one, and thereby allows a quiet tape application.

With reference to FIGS. 1, 3 to 5, the brake component 30 has an elastic structure 31. In the first embodiment, the elastic structure 31 is a substantial elastic arm which can be elastically deformed. In a first phase, with reference to FIG. 3, before the user starts operation, the transfer head 40 is located in the original position, an outer peripheral edge of the supply reel 21 abuts against and makes the elastic structure 31 deformed to a maximum level to have a most curved configuration. A radial abutting force applied on the supply reel 21 reaches a maximum and provides a maximum braking capacity, and then the supply reel 21 cannot be freely rotated.

In a second phase, with reference to FIG. 4, when the user starts operating and abuts the transfer head 40 onto the paper surface, the transfer head 40 moves from the original position toward the operating position, bringing the tape-supplying assembly 20 to move backwardly relative to the casing 10, the supply reel 21 gradually moves away from the brake component 30 and the elastic structure 31 gradually recovers into a less curved configuration. The elastic structure 31 in a less curved configuration makes the radial abutting force applied on the supply reel 21 gradually decrease, i.e. the braking capacity decreases, while the supply reel 21 becomes more and more rotatable.

Furthermore, in a third phase, with reference to FIG. 5, when the user has abutted the transfer head 40 to the operating position, the brake component 30 and the supply reel 21 become separate, and the braking capacity decreases to zero, forming a non-resisting state, so the supply reel 21 is more easily rotatable, favoring the user's tape application.

With only the first and the second phases, the film transfer tool of the present invention can achieve the main objective of the present invention. The third phase may be adopted upon demands. Additionally, the shape or configuration of the elastic structure 31 is not limited to the substantial elastic arm, and can be closed-loop shaped, V-shaped, or in any other shape, as long as the elastic structure 31 can change the braking capacity of the brake component for the supply reel 21 through different deformation levels.

Specifically, with reference to FIGS. 1 to 3, the casing 10 comprises a first shell 101 and a second shell 102, and the receiving space 103 is formed between the first shell 101 and the second shell 102. The first shell 101 and the second shell 102 are configured to pivot about each other for the sake of opening and closing the casing 10 for receiving the rest of the components in the receiving space 103.

The tape-supplying assembly 20 comprises a cassette including a loading rack 201 and a cover 22 mounted on the loading rack 201 so as to mount and position the supply reel 21 and the take-up reel 210 on the loading rack 201. In the first embodiment, the transfer head 40 is connected at a front end of the loading rack 201 and the cover 22, and the transfer tape 211 wraps over a front end of the transfer head 40. Also, the elastic component 50 is a compression spring located between the loading rack 201 of the tape-supplying assembly 20 and the casing 10.

Furthermore, with reference to FIGS. 1 to 3, the cover 22 has a through hole 221 formed thereon and communicating with an interior and an exterior of the cover 22. The brake component 30 is movably mounted to the cover 22 on an outer surface of the cassette and extends into the cover 22 via the through hole 221 for abutting against the outer peripheral edge of the supply reel 21. An interior of the second shell 102 of the casing 10 has a positioning part 11 positioning the brake component 30 on the casing 10, rather than moving along with the tape-supplying assembly 20, so as to move relative to the supply reel 21.

Preferably, the interior of the casing 10 has a position-limiting part 12 extending into the cassette, and the film transfer tool comprises a mounting post 23 located in the cover 22 of the cassette of the tape-supplying assembly 20 and being moveable along with the tape-supplying assembly 20. Specifically, the position-limiting part 12 extends into the cassette of the tape-supplying assembly 20 via an opening of the loading rack 201 and is aligned with the mounting post 23. The elastic component 50 is a compression spring having one of two ends sheathed on the mounting post 23 and the other end abutting against the position-limiting part 12. Thereby, the elastic component 50 is capable of being gradually deformed and elastically recovering, making the transfer head 40 and the tape-supplying assembly 20 work smoothly and lowering failure rate.

Besides, in the first embodiment, with reference to FIG. 3, the position-limiting part 12, the mounting post 23, and the elastic component 50 are disposed near the transfer head 40, making the resilient force of the elastic component 50 act on a location nearer to the transfer head 40, so restoring motions of the transfer head 40 and the tape-supplying assembly 20 become stabler and smoother, simultaneously reducing possibility of transverse deviation (upward/downward, compared to stable longitudinal movement) of the tape-supplying assembly 20, and thereby further improving movement stableness and lowering failure rate.

Preferably, with reference to FIGS. 1 to 4, the casing 10 has at least one guiding groove 13 inside, and an exterior of the tape-supplying assembly 20 has at least one positioning protrusion 24 configured to be inserted into said guiding groove 13 and guide the tape-supplying assembly 20 to move relative to the casing 10 from arbitrary deviation. In the first embodiment, both of the first shell 101 and the second shell 102 of the casing 10 have said guiding groove 13, and a top side of the cassette of the tape-supplying assembly 20 has said positioning protrusion 24 for extending into the guiding groove 13 of the second shell 102. Furthermore, the film transfer tool comprises a slide rack 60 mounted with the loading rack 201 of the tape-supplying assembly 20 and slidably mounted to the first shell 101, so as to be loaded with and bring the tape-supplying assembly 20 to move relative to the casing 10. After the transfer tape 211 runs out, the user may easily replace the tape-supplying assembly 20 on the slide rack 60 and slidably mount a new cassette of the tape-supplying assembly 20 in the casing 10. In the present configuration, the mounting post 23 to sheathe the elastic component 50 is formed on the slide rack 60. With reference to FIGS. 1 and 3, after the tape-supplying assembly 20 is downwardly assembled with the slide rack 60, the mounting post 23 is located in the cover 22 of the cassette of the tape-supplying assembly 20, making the elastic component 50 abut between the slide rack and the position-limiting part 12 of the first shell 101. In the first embodiment, the slide rack further has one said positioning protrusion 24 for extending into the guiding groove 13 of the first shell 101 and providing position-limiting effects on both of a top side and a bottom side of the tape-supplying assembly 20, and making movements even stabler and more reliable.

Preferably, the film transfer tool comprises a positioning structure. With reference to FIGS. 1, 3 to 5, in the first embodiment, the positioning structure is a positioning block 25 formed on the slide rack 60. With reference to FIG. 3, the positioning block 25 extends into the tape-supplying assembly 20. When the transfer head 40 is in the original position, the positioning block 25 and the position-limiting part 12 are disposed at a spaced interval. With reference to FIGS. 4 and 5, when the transfer head 40 is moving toward the operating position, the positioning block 25 moves along with the transfer head 40 and the tape-supplying assembly 20 toward the position-limiting part 12, and eventually abuts on the position-limiting part 12. By means of the positioning block 25 and the position-limiting part 12, a distance travelled by the transfer head 40 from the original position to the operating position can be controlled, so as to provide a better touch for tape application.

Besides, in other configurations, the slide rack 60 may be omitted, the mounting post 23 may be formed on the loading rack 201 of the tape-supplying assembly 20, and the positioning protrusions 24 may be formed on a bottom side of the loading rack 201, so as to achieve the elastic component mounting function and the stable sliding effect by both side position limiting. The positioning structure may also be disposed on the loading rack 201 of the tape-supplying assembly 20 or another component that is driven by the transfer head 40, and may be in other shapes or configurations, not limited to the configuration shown in the first embodiment of the present invention. As long as the distance travelled by the transfer head 40 relative to the casing 10 is limited within a certain range, a displacement of the transfer head 40 from the original position to the operating position can be controlled.

Preferably, the displacement of the transfer head 40 ranges from 0.4 to 2 millimeters (mm), end points included, thereby providing the best touch for tape application. If the displacement is below 0.4 mm, releasing of the brake component 30 may be incomplete and lead to a larger required force for tape application. If the displacement is above 2 mm, the transfer head 40 has to withdraw for an overwhelming distance, which may lead to a worse touch for tape application.

Besides, the brake component 30 may be one-piece formed on the interior of the casing 10, i.e. the elastic arm protrudes from the interior of the casing and is configured to move relative to the supply reel 21. The main objective of the present invention can also be fulfilled.

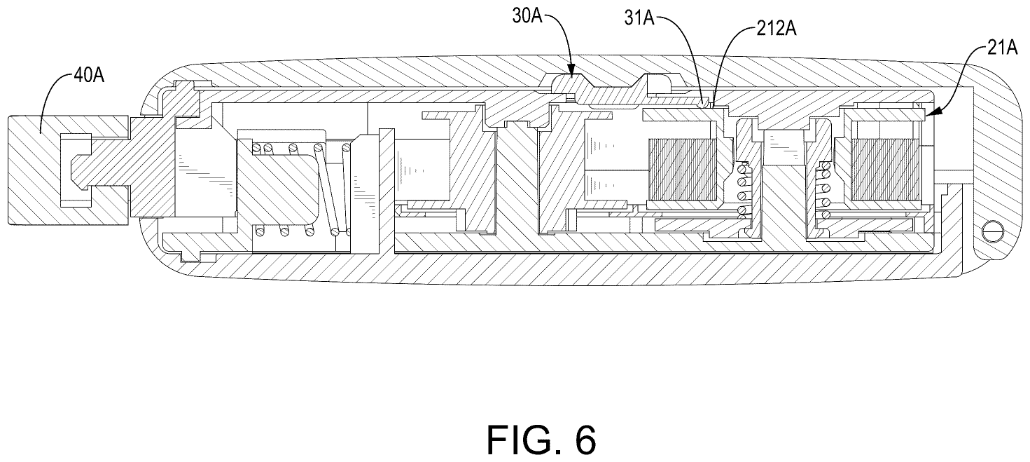

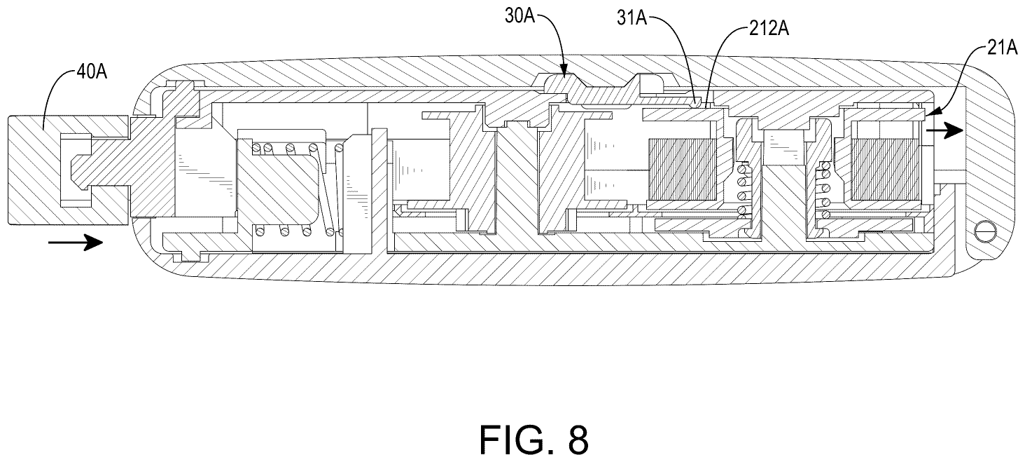

With reference to FIGS. 6 to 8, a second embodiment in accordance with the present invention differs from the first embodiment in that: the supply reel 21A has a roughened top 212A, and the brake component 30A comprises an elastic arm 31A having an end portion biased on a top 212A of the supply reel 21A and making the elastic arm 31A deformed. When the transfer head 40A moves from the original position (as shown in FIG. 6) toward the operating position (as shown in FIG. 8), the end portion of the elastic arm 31A moves on the top 212A of the supply reel 21A along a direction away from an axle of the supply reel 21A. That is, the end portion of the elastic arm 31A moves forwardly relative to the supply reel 21A. During this process, the length between where the supply reel 21A is abutted by the brake component 30A and the axle of the supply reel 21A gradually increases.

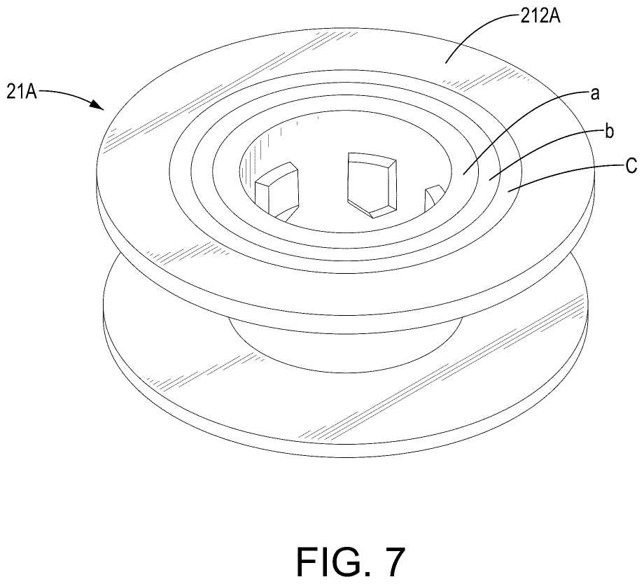

Furthermore, with reference to FIG. 7, the top 212A of the supply reel 21A forms a first roughened surface a, a second roughened surface b, and a third roughened surface c in order from inside to outside. A surface roughness of the first roughened surface a is greater than that of the second roughened surface b, and the surface roughness of the second roughened surface b is greater than that of the third roughened surface c (a>b>c), i.e. the surface roughness of the top 212A of the supply reel 21A radially decreases along the direction away from the axle of the supply reel 21A. Therefore, when the end portion of the elastic arm 31A moves forwardly relative to the supply reel 21A, the friction between the brake component 30A and the supply reel 21A gradually decreases. As long as a margin by which the friction decreases is greater than a margin by which said equivalent moment arm increases, and the braking capacity by the maximum static friction is greater than that by follow-up kinetic frictions, the effect of the gradually-decreasing braking capacity for the supply reel 21A offered by the brake component 30A can be achieved.

Additionally, the roughened surface of the top 212A of the supply reel 21A may lack clear distinguishable boundaries. As long as the surface roughness of the top 212A of the supply reel 21A increases along the direction away from axle of the supply reel 21A, the above-mentioned function can be achieved by changing coefficient of friction of the surface.

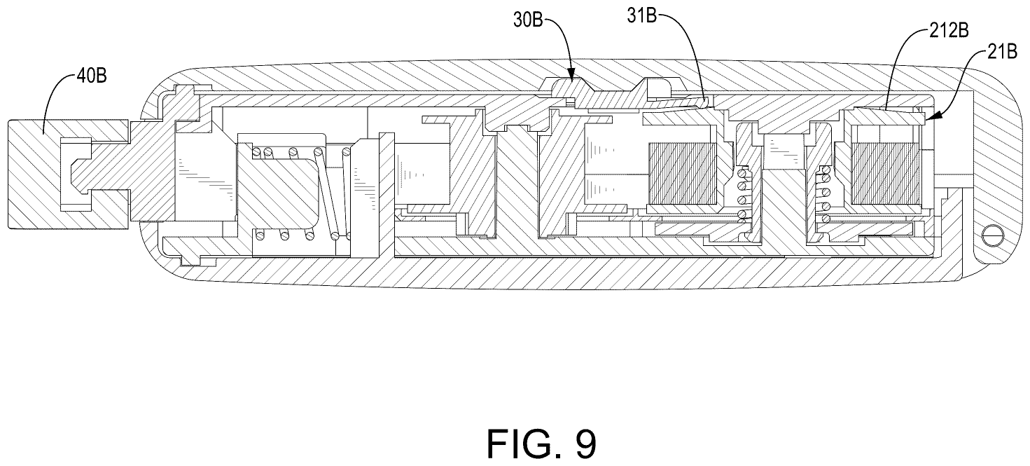

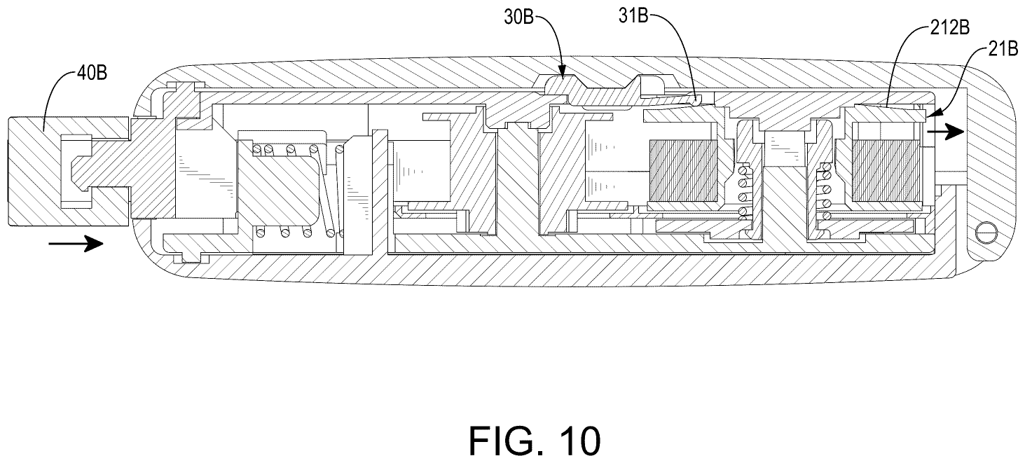

With reference to FIGS. 9 and 10, a third embodiment in accordance with the present invention differs from the second embodiment in that: the top of the supply reel 21B forms an inclined surface 212B, and a height of the inclined surface 212B gradually decreases along the direction away from the axle of the supply reel 21B. When the transfer head 40B moves toward the operating position, the end portion of the elastic arm 31B descends along the inclined surface 212B. Because the elastic arm 31B is elastically deformed and biased on the inclined surface 212B, when the end portion of the elastic arm 31B gradually descends, a normal force applied on the supply reel 21B by the end portion of the elastic arm 31B gradually decreases, and causes the friction between the brake component 30B and the supply reel 21B to decrease. Specifically, as long as a margin by which the friction between the brake component 30B and the supply reel 21B decreases is greater than a margin by which the length between where the brake component 30B abuts and the axle of the supply reel 21B increases, the effect of the gradually-decreasing braking capacity for the supply reel 21B offered by the brake component 30B can be achieved.

In addition, in the third embodiment, a gradient of the inclined surface 212B being a fixed value makes the inclined surface 212B an oblique viewed from a side. However, in other examples, the inclined surface 212B may be a curved line in the side view, as long as the normal force which the supply reel 21B bears can decrease. Changing the coefficient of friction in the second embodiment and changing the normal force in the third embodiment may be both adopted in a hybrid approach.

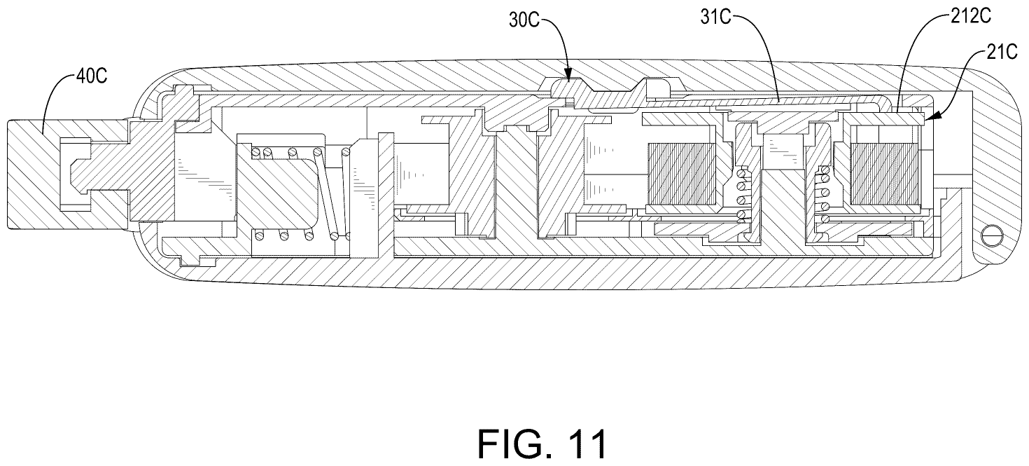

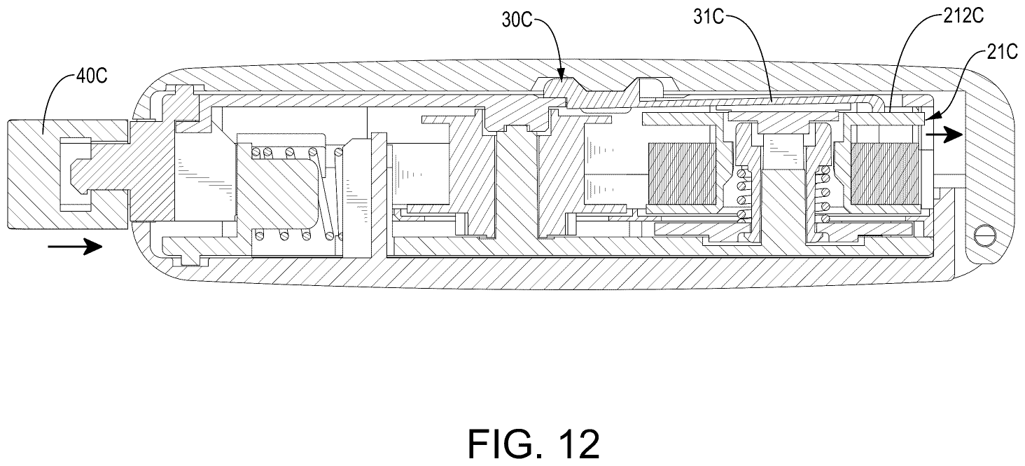

With reference to FIGS. 11 and 12, a fourth embodiment in accordance with the present invention differs from the first embodiment in that: the supply reel 21C has a top 212C, and the brake component 30C comprises an elastic arm 31C having an end portion biased on a top 212C. When the transfer head 40C moves from the original position (as shown in FIG. 11) toward the operating position (as shown in FIG. 12), the end portion of the elastic arm 31C moves on the top 212C of the supply reel 21C along a direction toward an axle of the supply reel 21C, i.e. the end portion of the elastic arm 31C moves forwardly relative to the supply reel 21C. During this process, the length between where the supply reel 21C is abutted by the brake component 30C and the axle of the supply reel 21C gradually decreases. Also, the top 212C has an even surface roughness, making the kinetic friction between the brake component 30C and the supply reel 21C a fixed value. Since the length between where the supply reel 21C is abutted by the brake component 30C and the axle of the supply reel 21C gradually decreases, the braking capacity offered by the brake component 30C gradually decreases, so as to achieve the above-mentioned technical effect.

In other examples, the top 212C may have uneven surface roughness or even be non-flat. As long as its effect on the kinetic friction is smaller than the effect from the decreasing length between where the supply reel 21C is abutted by the brake component 30C and the axle of the supply reel 21C, the above-mentioned technical effect can still be achieved.

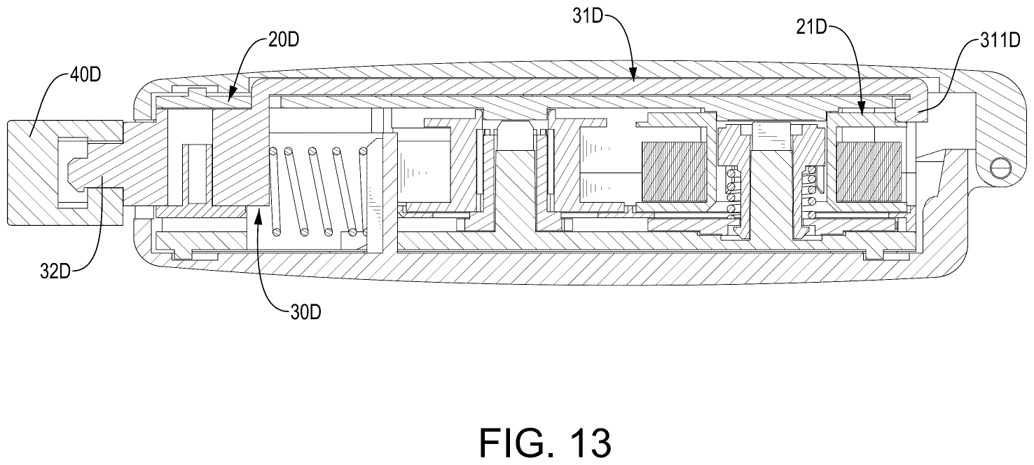

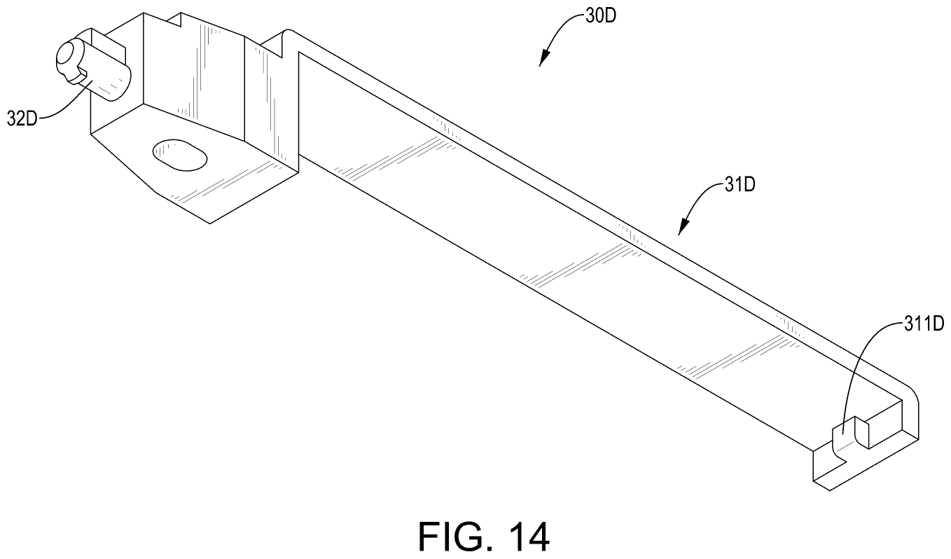

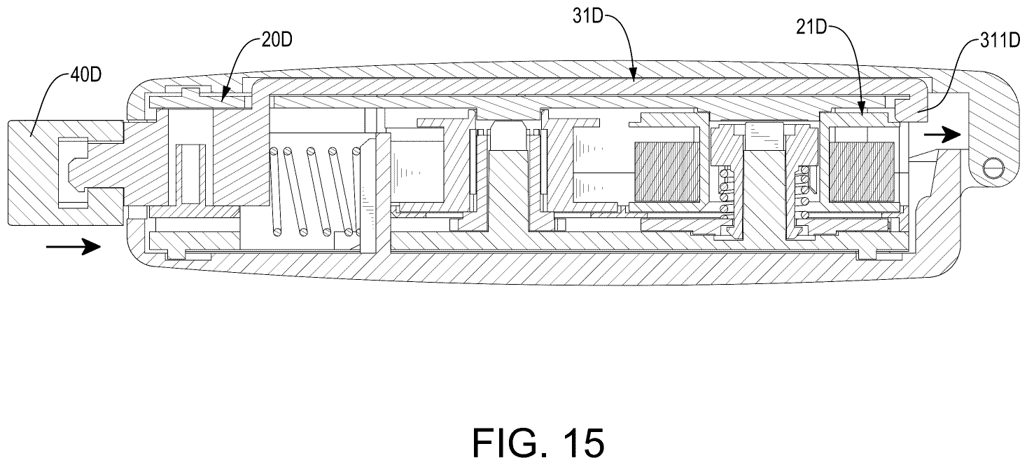

With reference to FIGS. 13 to 15, a fifth embodiment in accordance with the present invention differs from the first embodiment in that: the tape-supplying assembly 20D is firmly connected in the interior of the casing, and the brake component 30D is slidably mounted with the tape-supplying assembly 20D and has an extending arm 31D and a mounting portion 32D mounted with the transfer head 40D. The extending arm 31D extends backwardly to a rear side of the supply reel 21D, and by means of the resilient force of the elastic component 50D, hooks on the rear side of the supply reel 21D by an abutting block 311D so as to provide the braking capacity. As shown in FIG. 15, the application head 40D moves from the original position toward the operating position, bringing the brake component 30D to move relative to the supply reel 21D. The abutting block 311D originally abuts on both a top surface and a rear surface of a top portion of the supply reel 21D and eventually becomes only abutting on the top surface of the top portion and later departing from the supply reel 21D. The gradually-decreasing braking capacity to the supply reel 21D offered by the brake component 30D can thereby be achieved. Furthermore, the brake component 30D and the supply reel 21D may adopt the configurations disclosed in the first to the fourth embodiments to have a braking capacity adjustment effect.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A film transfer tool comprising:
a casing;
a tape-supplying assembly disposed in the casing and comprising a supply reel and a take-up reel linked with the supply reel;
a brake component disposed in the casing and configured to move relative to the supply reel;
a transfer head having an end extending into the casing and connected with the tape-supplying assembly, and the transfer head configured to move relative to the tape-supplying assembly between an original position and an operating position and drive one of the tape-supplying assembly and the brake component to move relative to the other one of the tape-supplying assembly and the brake component; and
an elastic component disposed in the casing and configured to provide a resilient force to drive the transfer head to move toward the original position;
wherein when the transfer head is located in the original position, the brake component abuts against the supply reel and provides a maximum braking capacity;
when the transfer head moves from the original position toward the operating position, a relative movement between the supply reel and the brake component is caused and the braking capacity gradually decreases.

2. The film transfer tool as claimed in claim 1, wherein
the brake component has an elastic structure;
when the transfer head is located in the original position, an outer peripheral edge of the supply reel abuts against the elastic structure, thereby deforming the elastic structure; and
when the transfer head moves from the original position toward the operating position, the supply reel gradually moves away from the brake component and make the elastic structure gradually recover.

3. The film transfer tool as claimed in claim 2, wherein when the transfer head is located in the operating position, the brake component and the supply reel are separate.

4. The film transfer tool as claimed in claim 1, wherein
the brake component comprises an elastic arm having an end portion biased on a top of the supply reel and deforming the elastic arm; and
when the transfer head moves from the original position toward the operating position, the end portion of the elastic arm moves on the top of the supply reel along a direction away from an axle of the supply reel.

5. The film transfer tool as claimed in claim 4, wherein
the top of the supply reel forms an inclined surface;
a height of the inclined surface gradually decreases along the direction away from the axle of the supply reel; and
when the transfer head moves toward the operating position, the end portion of the elastic arm descends along the inclined surface.

6. The film transfer tool as claimed in claim 4, wherein a surface roughness of the top of the supply reel radially decreases along the direction away from the axle of the supply reel.

7. The film transfer tool as claimed in claim 1, wherein
the brake component comprises an elastic arm having an end portion biased on a top of the supply reel; and
when the transfer head moves from the original position toward the operating position, the end portion of the elastic arm moves on the top of the supply reel along a direction toward an axle of the supply reel.

8. The film transfer tool as claimed in claim 1, wherein a displacement of the transfer head from the original position to the operating position ranges from 0.4 to 2 millimeters (mm), end points included.

9. The film transfer tool as claimed in claim 1, wherein
the casing has at least one guiding groove; and
an exterior of the tape-supplying assembly has at least one positioning protrusion configured to be inserted into said guiding groove and guide the tape-supplying assembly to move relative to the casing.

10. The film transfer tool as claimed in claim 1, wherein the film transfer tool comprises a slide rack mounted with the tape-supplying assembly and slidably mounted to the casing, so as to be loaded with and bring the tape-supplying assembly to move relative to the casing.

11. The film transfer tool as claimed in claim 1, wherein the transfer head is capable of bringing the tape-supplying assembly to move relative to the casing.

12. The film transfer tool as claimed in claim 11, wherein the elastic component is a compression spring located between the tape-supplying assembly and the casing.

13. The film transfer tool as claimed in claim 11, wherein
the tape-supplying assembly comprises a cassette;
the brake component is movably mounted to an outer surface of the cassette and extends into the cassette for abutting against the supply reel; and
an interior of the casing has a positioning part positioning the brake component on the casing.

14. The film transfer tool as claimed in claim 13, wherein
the interior of the casing has a position-limiting part extending into the cassette;
the film transfer tool comprises a mounting post located in the cassette of the tape-supplying assembly; and
the elastic component is a compression spring having
one of two ends sheathed on the mounting post; and
the other one of the two ends abutting against the position-limiting part.

15. The film transfer tool as claimed in claim 14, wherein the position-limiting part, the mounting post, and the elastic component are disposed near the transfer head.

16. The film transfer tool as claimed in claim 14, wherein the film transfer tool comprises a positioning block configured to move relative to the casing along with the transfer head and abut against the position-limiting part, so as to restrain a distance travelled by the transfer head from the original position to the operating position.
